(19) United States
(12) Patent Application Publication
(10) Pub. No.: US 2007/0203292 A1
(43) Pub. Date: Aug. 30, 2007

(54) Composition Comprising A Non-Functionalized Polyolefin And A Graft Polyolefin And Article Produced Using This Composition

(75) Inventors: Henri Wautier, Braine-le-comte (BE); Dino Manfredi, Lummen (BE); Pierre Dalet, Sauternes (FR); Marie-Paule Collard, Vilvoorde (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: Solvay (Societe Anonyme), Bruelles (BE)

(21) Appl. No.: 10/573,652

(22) PCT Filed: Sep. 29, 2004
(86) PCT No.: PCT/EP04/52364

§ 371 Date: Dec. 8, 2006

(30) Foreign Application Priority Data
Sep. 29, 2003 (FR) 03.11395
Sep. 29, 2003 (FR) 03.11394
Feb. 27, 2004 (EP) PCTEP0402082
Aug. 13, 2004 (BE) 2004/0398

(51) Int. Cl. C08L 51/00

(52) U.S. Cl. 525/70

(57) ABSTRACT

Polymer composition comprising more than 50 % by weight, with respect to the total weight of the composition, of a nonfunctionalized polyolefin (PO1), and more than 0.5 % by weight, with respect to the total weight of the composition, of at least one polyolefin comprising carboxyl grafts [polyolefin (POg)] which is functionalized by grafting using at least one grafting agent chosen from ethylenically unsaturated carboxylic acids, their anhydrides and their metal salts, at least a portion of the carboxyl grafts of which is neutralized by a metal, optionally by the neutralization, concomitant with and/or subsequent to the grafting, of the carboxyl grafts by at least one metal base, and which has been synthesized from a nonfunctionalized polyolefin (PO2), at least 0.5 % by weight and at most 50 % by weight of the repeat units of which are derived from at least one ethylenically unsaturated monomer which has a different chemical nature from that of the repeat units of the nonfunctionalized polyolefin (PO). Article comprising the composition described above.

The present invention relates to a polymer composition comprising a nonfunctionalized polyolefin and a grafted polyolefin, and to an article manufactured by employing such a composition.

For several decades, various substrates (in particular sheets of paper, metal sheets or plates, textiles surfaces or fibres, organic or inorganic fibres, foodstuffs) have been coated, in order to preserve them and to protect them, with substances such as paraffins or blends of paraffins and of ethylene/vinyl acetate copolymers.

A number of substrates formerly coated with paraffins and with ethylene/vinyl acetate copolymers have been replaced by substrates coated with unmodified polyolefin, in particular with unmodified polyethylene or with unmodified polypropylene, as the latter generally have better transparency, a greater ultimate strength and greater stiffness. However, the latter still present many problems; in particular, the coating of unmodified polyolefin usually adheres in a mediocre fashion to the substrate itself.

Provision has already been made, in order to improve the adhesion of the polyolefin to the substrate, to modify the polyolefin chemically by grafting with acid and/or anhydride groups. In that way, a substantial improvement in the adhesion has usually been obtained. However, this improvement generally remains at a lower level than that desired and, in addition, this technical solution is much more expensive.

Provision has also already been made, for the purpose of improving in particular the adhesion to a metal support of thermoplastic polymers (in particular vinyl polymers), to replace the thermoplastic polymers with blends comprising from 20 to 60% of an ethylene/propylene (EPR, EPDM) copolymer elastomer and from 40 to 80% of an ionomer which is a copolymer of ethylene and of a carboxylic acid neutralized in all or in part by metal ions (U.S. Pat. No. 4,371,583, on behalf of Schulman, Inc.). The content of repeat units derived from carboxylic acid in the ionomer is very high: in the case of Surlyn® zinc ionomer, which is used in the examples of U.S. Pat. No. 4,371,583, it reaches approximately 10%. Nevertheless, just like the preceding compositions, the elastomer-ionomer compositions envisaged in U.S. Pat. No. 4,371,583 generally exhibit a poorer adhesion than desired, are very expensive and display other weaknesses, in particular inadequate stiffness.

Finally, provision has been made to replace the unmodified polyolefin with a blend of the unmodified polyolefin and of a polyolefin to which acid and/or anhydride groups have been grafted. Thus, U.S. Pat. No. 3,856,889 (Eastman Kodak Co.) discloses blends of unmodified polyethylene and of a poly-α-olefin (in particular of polypropylene) grafted with acid or anhydride groups which have an improved adhesion to substrates in comparison with the unmodified polyethylene. Admittedly, this solution might solve the problem of cost mentioned above but the improvement in the adhesion generally remains inadequate.

Patent Application US 2002/0107329 (Ding et al.) discloses generically blends comprising a propylene polymer modified with (grafted or copolymerized) acid or anhydride groups neutralized by a metal salt and an ethylene polymer grafted with (grafted or copolymerized) acid or anhydride groups also neutralized by the metal salt. Numerous embodiments are envisaged therein. In particular, according to one of them, the abovementioned blend can additionally comprise a polyolefin, in particular an unmodified propylene polymer (section [0030]). According to another, the abovementioned blend can additionally comprise up to 40 parts by weight of an elastomeric agent which modifies impact strength chosen from copolymers of ethylene and of an α-monoolefin [sections 0077 and 0083]. According to Ding et al., the blends concerned exhibit both excellent resistance to scratching and an excellent impact strength; in contrast, Ding et al. provide no teaching with regard to the adhesion to a support of the same blends.

A subject-matter of the present invention is a polymer composition comprising a nonfunctionalized polyolefin and a grafted polyolefin which exhibits numerous advantages, in particular an improved adhesion, in comparison with the compositions comprising a nonfunctionalized polyolefin and a grafted polyolefin of the prior art without exhibiting the disadvantages thereof.

To this end, the invention relates to a polymer composition comprising
more than 50% by weight, with respect to the total weight of the composition, of a nonfunctionalized polyolefin (PO1), and
more than 0.5% by weight, with respect to the total weight of the composition, of at least one polyolefin comprising carboxyl grafts [polyolefin (POg)] which is functionalized by grafting using at least one grafting agent chosen from ethylenically unsaturated carboxylic acids, their anhydrides and their metal salts, at least a portion of the carboxyl grafts of which is neutralized by a metal, optionally by the neutralization, concomitant with and/or subsequent to the grafting, of the carboxyl grafts by at least one metal base, and which has been synthesized from a nonfunctionalized polyolefin (PO2), at least 0.5% by weight and at most 50% by weight of the repeat units of which are derived from at least one ethylenically unsaturated monomer which has a different chemical nature from that of the repeat units of the nonfunctionalized polyolefin (PO1).

A nonfunctionalized polyolefin within the meaning of the present invention is a polyolefin devoid of functional group of whatever nature and under whatever form (inter alia the functional group can be copolymerized or grafted); a nonfunctionalized polyolefin within the meaning of the present invention is in particular devoid of repeat units derived from an ethylenically unsaturated comonomer exhibiting at least one functional group, such as ethylenically unsaturated carboxylic acids, their metal salts and their esters, or vinyl esters; it is also devoid of functional groups grafted using grafting agents such as ethylenically unsaturated carboxylic acids, their anhydrides, their metal salts and their esters.

The term “polyolefin” is understood to denote a polymer, more than 50% by weight of the repeat units of which are derived from at least one olefine.

The term “olefin” is understood here to denote a monoolefin. The olefin can in particular be branched or linear. Mention may be made, as examples of linear olefins, of ethylene, propylene, 1-butene, 1-pentene, 1-hexene, 1-heptene, 1-octene, 1-nonene and 1-decene.

The nonfunctionalized polyolefin (PO1) is preferably a polymer, more than 50% by weight of the repeat units of which are derived from the same olefin (O1).

The olefin (O1) is preferably linear.

The olefin (O1) preferably comprises from 2 to 8 carbon atoms, particularly preferably from 2 to 6 carbon atoms and very particularly preferably from 2 to 4 carbon atoms. Excellent results have been obtained when (O1) was propylene.

The nonfunctionalized polyolefin (PO1) can in particular be a homopolymer or a copolymer.

The optional comonomers of the olefin (O1) are advantageously chosen from the linear olefins described above and from diolefins comprising from 4 to 18 carbon atoms, such as 4-vinylcyclohexene, dicyclopentadiene, methylene- and ethylidenenorbomene, 1,3-butadiene, isoprene and 1,3-pentadiene. They are preferably chosen from the above linear olefins.

Preferably, at least 90% by weight, particularly preferably at least 94% by weight and very particularly preferably at least 97% by weight of the repeat units of the nonfunctionalized polyolefin (PO1) are derived from the olefin (O1). More preferably still, the nonfunctionalized polyolefin (PO1) is a homopolymer.

Excellent results have been obtained when the nonfunctionalized polyolefin (PO1) was a propylene homopolymer, such as the propylene homopolymers Eltex® P HL.

The term “carboxyl grafts” is understood to denote acid and/or anhydride groups grafted to a polymer, in the case here a polyolefin.

The grafting agent can be a monoethylenically unsaturated monocarboxylic or dicarboxylic acid or an anhydride or a metal salt derived from the mono- or diacid.

The grafting agent preferably comprises from 3 to 20 carbon atoms.

The grafting agent is particularly preferably chosen from acrylic acid, methacrylic acid, maleic acid, fumaric acid, itaconic acid, crotonic acid, citraconic acid, maleic anhydride, itaconic anhydride, crotonic anhydride and citraconic anhydride. Maleic anhydride is very particularly preferred as grafting agent.

The amount of carboxyl grafts, with respect to the weight of the polyolefin (POg), is advantageously greater than 0.01% by weight, preferably greater than 0.02% by weight and particularly preferably greater than 0.03% by weight. In addition, this amount is advantageously less than or equal to 2.0% by weight, preferably less than or equal to 1.5% by weight and particularly preferably less than or equal to 1.0% by weight.

The grafting of the carboxyl grafts is advantageously initiated by a radical-generating agent. Mention may in particular be made, as examples of radical-generating agents, of t-butyl cumyl peroxide, 1,3-di(2-(t-butylperoxy)isopropyl)benzene, 2,5-dimethyl-2,5-di(t-butylperoxy)hexane, di(t-butyl)peroxide and 2,5-dimethyl-2,5-di(t-butylperoxy)-3-hexyne. 2,5-Dimethyl-2,5-di(t-butylperoxy)hexane (DHBP) has made it possible to synthesize grafted polyolefins which have given good results relating to the different aspects of the present invention.

The polyolefin (POg) advantageously comprises little in the way of free (ungrafted) grafting agent, typically an amount of less than or equal to 500 ppm, preferably of less than 400 ppm and particularly preferably 200 ppm. To this end, the polyolefin (POg) has advantageously been purified from free grafting agent, preferably by entrainment with acetone, by stripping with hot air, by stripping with steam, by stripping with an inert gas or also by degassing.

As indicated above, at least a portion of the carboxyl grafts present in the polyolefin (POg) is neutralized by a metal.

The neutralization of the carboxyl grafts can be obtained in particular (i) using a grafting agent chosen from the metal salts of the carboxylic acids (such as disodium maleate, sodium acrylate or zinc acetate) or (ii) by the neutralization, concomitant with and/or subsequent to the grafting, of the carboxyl grafts (resulting, if appropriate, from a grafting agent chosen from carboxylic acids and their anhydrides) by at least one metal base. The neutralization of the carboxyl grafts is preferably obtained by the route (ii).

The metal base can be an inorganic salt, an organic salt or also a mixture of an organic salt and of an inorganic salt.

The inorganic salt, whether used alone or as a mixture, is preferably a hydroxide, a carbonate, a bicarbonate, a phosphate or a monohydrogenphosphate, of an alkali metal. Sodium carbonate is particularly preferred.

The organic salt, whether used alone or as a mixture, is preferably a carboxylate or a mono- or polyhydroxycarboxylate of a metal which can in particular be an alkali metal, an alkaline earth metal, a metal from group IIIa of the Periodic Table of the Elements or a transition metal. Particularly preferably, the organic salt is a carboxylate of a transition metal or a mono- or polyhydroxycarboxylate of an alkali metal. Very particularly preferably, the organic salt is chosen from sodium lactate and zinc acetate.

The metal base is preferably an organic salt or a mixture of an organic salt and of an inorganic salt. Particularly preferably, the metal base is a mixture of an organic salt and of an inorganic salt.

Excellent results have been obtained using, as metal base, either a mixture of sodium lactate and of sodium carbonate or a mixture of zinc acetate and of sodium carbonate.

The metal base is used in an amount preferably of greater than 0.5 molar equivalent with respect to the number of carboxyl grafts of the polyolefin (POg). Furthermore, the neutralizing agent is used in an amount preferably of less than 3 mol. eq. with respect to the number of carboxyl grafts of the polyolefin (POg).

The nonfunctionalized polyolefin (PO2) is preferably a polymer, more than 50% by weight of the repeat units of which are derived from the same olefin (O2).

The olefin (O2) is preferably linear.

The olefin (O2) preferably comprises from 2 to 8 carbon atoms, particularly preferably from 2 to 6 carbon atoms and very particularly preferably from 2 to 4 carbon atoms. Excellent results have been obtained when the olefin (O2) was propylene.

The nonfunctionalized polyolefin (PO2) can in particular be a homopolymer or a copolymer.

The optional comonomers of the olefin (O2) are advantageously chosen from the linear olefins described above and from diolefins comprising from 4 to 18 carbon atoms, such as 4-vinylcyclohexene, dicyclopentadiene, methylene- and ethylidenenorbomene, 1,3-butadiene, isoprene and 1,3-pentadiene. They are preferably chosen from the above linear olefins. It is particularly preferable for the optional comonomer of the olefin (O2) to be ethylene, provided, of course, that the olefin (O2) itself differs from ethylene; in the specific case where the olefin (O2) is ethylene, it is particularly preferable for the optional comonomer of the olefin (O2) to be propylene or 1-butene.

Preferably, at least 80% by weight, particularly preferably at least 90% by weight and very particularly preferably at least 94% by weight of the repeat units of the nonfunctionalized polyolefin (PO2) are derived from the olefin (O2).

Advantageously, at most 99% by weight and preferably at most 98% by weight of the repeat units of the nonfunctionalized polyolefin (PO2) are derived from the olefin (O2).

The nonfunctionalized polyolefin (PO2) is advantageously other than an elastomer and preferably other than an agent which modifies impact strength.

Excellent results have been obtained when the nonfunctionalized polyolefin (PO2) was a random copolymer of propylene and of ethylene (that is to say, a random copolymer composed of repeat units derived from ethylene and from propylene) comprising at least 94% by weight and at most 98% by weight of repeat units derived from propylene.

Preferably, at least 1% by weight and particularly preferably at least 2% by weight of the repeat units of the nonfunctionalized polyolefin (PO2) are derived from at least one ethylenically unsaturated monomer which is different in chemical nature from that of the repeat units of the nonfunctionalized polyolefin (PO1).

Preferably, at most 20% by weight, particularly preferably at most 10% by weight and very particularly preferably at most 6% by weight of the repeat units of the nonfunctionalized polyolefin (PO2) are derived from at least one ethylenically unsaturated monomer which is different in chemical nature from that of the repeat units of the nonfunctionalized polyolefin (PO1).

Advantageously, the nonfunctionalized polyolefins (PO1) and (PO2) each exhibit a melting point.

Preferably, the nonfunctionalized polyolefins (PO1) and (PO2) each exhibit a melting point and their respective enthalpies of fusion differ by an amount of greater than 10 J/g.

Particularly preferably, the nonfunctionalized polyolefins (PO1) and (PO2) each exhibit a melting point and their respective enthalpies of fusion differ by an amount of between 10 and 100 J/g.

Very particularly preferably, the nonfunctionalized polyolefins (PO1) and (PO2) each exhibit a melting point and their respective enthalpies of fusion differ by an amount of between 25 and 75 J/g.

The enthalpy of fusion is advantageously determined by differential scanning calorimetry at the 2nd heating phase and with a scanning rate of 10° C./min during the heating phases and of 20° C./min during the intermediate cooling [the sample is heated at the rate of 10° C./min from ambient temperature up to a temperature greater than its melting point (1st heating phase); subsequently, it is cooled at the rate of 20° C./min down to ambient temperature; finally, it is again heated at the rate of 10° C./min from ambient temperature up to a temperature greater than its melting point (2nd heating phase)].

Most preferably, the nonfunctionalized polyolefins (PO1) and (PO2) each exhibit a melting point and their respective enthalpies of fusion differ by an amount of between 30 and 60 J/g.

The weight of the nonfunctionalized polyolefin (PO1) with respect to the total weight of the composition is advantageously greater than or equal to 80%, preferably greater than or equal to 90% and particularly preferably greater than or equal to 93%.

The weight of the nonfunctionalized polyolefin (PO1) with respect to the total weight of the composition is advantageously less than or equal to 99%, preferably less than or equal to 98% and particularly preferably less than or equal to 97%.

The weight of the polyolefin (POg) with respect to the total weight of the composition has a value advantageously of at most 20%, preferably of at most 10% and particularly preferably of at most 7%.

The weight of the polyolefin (POg) with respect to the total weight of the composition has a value advantageously of at least 1%, preferably of at least 2% and particularly preferably of at least 3%.

The composition according to the invention can be prepared by any known process, in particular solution processes, processes taking place in a mixer, for example a Brabender® mixer, and processes taking place in an extruder, for example a Prism® extruder. Good results are usually obtained if the compositions according to the invention are prepared by a process taking place in an extruder.

The composition according to the invention can optionally comprise, in addition, conventional additives for polyolefin compositions in an amount advantageously ranging up to 40% by weight, preferably up to 10% by weight and particularly preferably up to 5% by weight, with respect to the total weight of the composition.

Mention may be made, as examples of such conventional additives, of antioxidants, such as sterically hindered phenols, lubricants, fillers, colorants, nucleating agents, UV stabilizers, antacids, such as calcium stearate, metal-deactivating agents and antistatic agents.

The composition according to the invention is advantageously devoid of polymer other than the polyolefins (PO1) and (POg).

The composition according to the present invention exhibits an overall level of properties which is markedly improved in comparison with that of the compositions comprising a nonfunctionalized polyolefin and a grafted polyolefin of the prior art. The surface properties are particularly improved. Thus, the composition according to the present invention exhibits better adhesive properties than those of the compositions comprising a nonfunctionalized polyolefin and a grafted polyolefin of the prior art.

Another subject-matter of the present invention is an article comprising a polymer composition which exhibits numerous advantages in comparison with the articles comprising a composition comprising a nonfunctionalized polyolefin and a grafted polyolefin of the prior art without exhibiting disadvantages thereof.

To this end, the invention relates to an article comprising the composition in accordance with the invention as described above.

The article according to the invention can be chosen in particular from pipes, films and sheets, fibres and foams made of the composition.

The article according to the invention can also in particular be a component of a motor vehicle selected from fuel tanks, fuel pipes, bumpers and dashboards.

The article according to the invention can also in particular be a substrate coated with a composition as described above. The substrate can, for example, be chosen from sheets of paper, metal sheets and plates, textile surfaces and fibres, organic fibres and inorganic fibres, and foodstuffs.

The article according to the invention is preferably a substrate coated with a composition as described above.

There are numerous advantages to the article in accordance with the invention. In particular, in the case of the substrate coated with the composition, the adhesion of the composition to the substrate is generally excellent, a significant improvement in comparison with the adhesion of the articles of the prior art.

The examples which follow are intended to illustrate the invention without, however, limiting the scope thereof.

### EXAMPLE 1

### Preparation of a Polyolefin Grafted with Maleic Anhydride which is Based on a Random Propylene (PP) Copolymer and which is Neutralized with Sodium Lactate (POg1)

Use was made, as reactant (a), of a resin Priex® 25097, a random polypropylene copolymer chemically modified by Solvay.

The random PP copolymer on which Solvay carried out the chemical modification is a random copolymer composed of 95 to 98% by weight of repeat units derived from propylene and of 2 to 5% by weight of repeat units derived from ethylene sold by BP under the name Eltex® KS. It exhibits a melting point of 132° C. and an enthalpy of fusion of 66 J/g.

The chemical modification which was carried out by Solvay on the abovementioned random PP copolymer consisted in grafting with maleic anhydride in a proportion of 0.50% by weight.

The resin Priex® 25097 had a weight-average molecular weight of 50 000.

Use was also made, as reactants, of:
(b) sodium lactate as neutralizing agent (sodium lactate: mixture of D- and L-isomer from Acros : 256.4 ml of solution comprising 60% by weight per litre of aqueous solution) in a proportion of 5 mol. eq.
(c) disodium carbonate in a proportion of 2 mol. eq. in the form of a 200 g/l aqueous solution.

The reactants (a), (b) and (c) were reacted in a Clextral model BC 21 extruder, which is a co-rotating twin-screw extruder with a diameter of 25 mm and a length of 1000 mm (L/D=40).

The barrel of this extruder is composed of 10 independent zones (Z1 to Z10), as well as of a convergence section and of a die. The screw speed was 200 revolutions/min. The feed throughput was 10 kg/h. The temperature profile was as follows: Z1 (feeding the resin): 70° C.; Z2: 170° C.; Z3 (melting) and Z4: 200° C.; Z5 to Z8 (reaction, venting at atmospheric pressure, reaction, venting under vacuum at a set value of 2 mbar): 240° C.; Z9: 230° C.; Z10: 220° C.; convergence section and die: 220° C.

High pressure injectors were used for the injection in Z4 of the sodium lactate and in Z7 of the disodium carbonate.

A polyolefin grafted with maleic anhydride which is based on a random PP copolymer and which is neutralized with sodium lactate [resin (POg1)] was thus obtained, the MFI (2.16 kg, 230° C.) of which had a value of 1.6 g/10 min. The resin (POg1) had a sodium content of 6.1 g/kg and its melting point was 135° C.

### EXAMPLE 2

### Preparation of a Polyolefin Grafted with Maleic Anhydride which is Based on a Propylene (PP) Homopolymer and which is Neutralized with Sodium Lactate (POg2)

Use was made, as reactant (a′), of a resin Priex® 20093, a polypropylene homopolymer chemically modified by Solvay.

The PP homopolymer on which Solvay carried out the chemical modification is sold by BP under the name Eltex® P HL. It exhibits a melting point of 163° C. and an enthalpy of fusion of 111 J/g.

The chemical modification which was carried out by Solvay on the abovementioned PP homopolymer consisted in grafting with maleic anhydride in a proportion of 0.26% by weight.

The resin Priex® 20093 had a weight-average molecular weight of 75 000.

Use was also made, as reactants, of (b) and (c) as defined in Example 1 (nature, amount, conditioning).

The reactants (a′), (b) and (c) were reacted in the Clextral model BC 21 extruder under operating conditions in every respect identical to those used for Example 1.

A polyolefin grafted with maleic anhydride which is based on a PP homopolymer and which is neutralized with sodium lactate (resin POg2) was thus obtained, the MFI (2.16 kg, 230° C.) of which had a value of 1.4 g/10 min. The resin (POg2) had a sodium content of 3.1 g/kg and its melting point was 165° C.

### EXAMPLE 3

### Preparation of Reference Compositions (Not in Accordance with the Invention)

Composition (RC1): Composition Based on a Random PP Copolymer.

Use was made, for first reference composition, hereinafter composition (RC1), of a composition Eltex® P KS sold by BP in the form of stabilized granules. This composition is composed of (i) more than 99.5% by weight, with respect to the total weight of the composition, of a random copolymer composed of 95 to 98% by weight of repeat units derived from propylene and of 2 to 5% by weight of repeat units derived from ethylene and (ii) less than 0.5% by weight, with respect to the total weight of the composition, of a sterically hindered phenol stabilizing agent.

Composition (RC2): Composition Based on a PP Homopolymer.

Use was made, for second reference composition, hereinafter composition (RC2), of a composition Eltex® P HL sold by BP in the form of stabilized granules. This composition is composed of (i) more than 99.5% by weight, with respect to the total weight of the composition, of a propylene homopolymer and (ii) less than 0.5% by weight, with respect to the total weight of the composition, of a sterically hindered phenol stabilizing agent.

Composition (RC3): Composition Based on a Random PP Copolymer and on a Random PP Copolymer Grafted with Maleic Anhydride which is Neutralized with Sodium Lactate.

A third reference composition, hereinafter composition (RC3), was prepared which is composed of 95% by weight of the composition (RC1) and of 5% by weight of the resin (POg1) synthesized in Example 1.

To this end, use was made of a Prism® co-rotating twin-screw extruder with a diameter of 15 mm and a length of 24 cm (i.e., a ratio of length to diameter of 16), the barrel of which is composed of 2 independent zones (Z1 and Z2), as well as of a convergence section and of a hole die. A screw speed of 200 rev/min and a throughput of 2 kg/h were applied and the temperature profile was as follows: Z1 (feeding zone): 230° C.; Z2: 230° C.; convergence section and die: 230° C.

Composition (RC4): Composition Based on a PP Homopolymer and on a PP Homopolymer Grafted with Maleic Anhydride which is Neutralized with Sodium Lactate.

A fourth reference composition, hereinafter composition (RC4), was prepared which is composed of 95% by weight of the composition (RC2) and of 5% by weight of the resin (POg2) synthesized in Example 2.

To this end, use was made of the same equipment and the same operating conditions as those used for the preparation of the composition (RC3).

### EXAMPLE 4

### Preparation of a Composition in Accordance with the Invention

Composition (IC5): Composition Based on a PP Homopolymer and on a Random PP Copolymer Grafted with Maleic Anhydride which is Neutralized with Sodium Lactate.

A composition in accordance with the invention, hereinafter composition (IC5), was prepared which is composed of 95% by weight of the composition (RC2) and of 5% by weight of the resin (POg1) synthesized in Example 1.

To this end, use was made of the same equipment and the same operating conditions as those used for the preparation of the composition (RC3).

### EXAMPLE 5

### Tests for Evaluating the Cohesion and the Adhesion to a Steel Plate Treated in a Chromic Acid/Sulphuric Acid Bath

These tests were carried out according to Standard NF T 76-104.

The shear test specimens were prepared by compressing, at a temperature of 230° C. and under a pressure of 20 bar, between two steel plates immersed beforehand for 10 minutes in a chromic acid/sulphuric acid bath.

The tensile strength (τ_{R}) of the shear test specimens was determined in a shear test carried out using an MTS 50LP device equipped with a 50 kN sensor.

The following results were obtained:

| | τ_{R} |
|---|---|
| | (MPa) |
| Composition (RC1): | 2 |
| Composition based on a random PP copolymer | |
| Composition (RC2): | 2 |
| Composition based on a PP homopolymer | |
| Composition (RC3): Composition based on a random PP | 7 |
| copolymer and on a random PP copolymer grafted with maleic | |
| anhydride which is neutralized with sodium lactate | |
| Composition (RC4): Composition based on a PP homopolymer | 7 |
| and on a PP homopolymer grafted with maleic anhydride which | |
| is neutralized with sodium lactate | |
| Composition (IC5): Composition based on a PP homopolymer | 10 |
| and on a random PP copolymer grafted with maleic anhydride | |
| which is neutralized with sodium lactate | |

It was found that the composition (IC5), which was based on a nonfunctionalized polyolefin (PO1) and on an ionomer of a grafted polyolefin formed from a nonfunctionalized polyolefin (PO2) which is different from the nonfunctionalized polyolefin (PO1) in the sense that the said nonfunctionalized polyolefin (PO2) comprised from 2 to 5% by weight of repeat units derived from ethylene whereas (PO1) was composed solely of repeat units derived from propylene, exhibited better adhesive properties, in particular than the composition (RC4), which was based on nonfunctionalized polyolefin (PO1) and on an ionomer of a grafted polyolefin formed from the same nonfunctionalized polyolefin (PO1).

1-14. (canceled)

15. A polymer composition comprising:
more than 50% by weight, with respect to the total weight of the composition, of a nonfunctionalized polyolefin (PO1); and
more than 0.5% by weight, with respect to the total weight of the composition, of at least one polyolefin comprising carboxyl grafts [polyolefin (POg)] which is functionalized by grafting using at least one grafting agent chosen from ethylenically unsaturated carboxylic acids, their anhydrides and their metal salts, at least a portion of the carboxyl grafts of which is neutralized by a metal, optionally by the neutralization, concomitant with and/or subsequent to the grafting, of the carboxyl grafts by at least one metal base, and which has been synthesized from a nonfunctionalized polyolefin (PO2), at least 0.5% by weight and at most 50% by weight of the repeat units of which are derived from at least one ethylenically unsaturated monomer which has a different chemical nature from that of the repeat units of the nonfunctionalized polyolefin (PO1).

16. The composition according to claim 15, wherein that more than 50 by weight of the repeat units of the nonfunctionalized polyolefin (PO1) are derived from propylene.

17. The composition according to claim 16, wherein that the nonfunctionalized polyolefin (PO1) is a propylene homopolymer.

18. The composition according to claim 15, wherein more than 50% by weight of the repeat units of the nonfunctionalized polyolefin (PO2) are derived from propylene.

19. The composition according to claim 18, wherein the nonfunctionalized polyolefin (PO2) is a random copolymer of propylene and of ethylene comprising at least 94% by weight and at most 98% by weight of repeat units derived from propylene.

20. The composition according to claim 15, wherein at least 1% by weight of the repeat units of the nonfunctionalized polyolefin (PO2) are derived from an ethylenically unsaturated monomer which is different in chemical nature from that of the repeat units of the nonfunctionalized polyolefin (PO1).

21. The composition according to claim 20, wherein at least 2% by weight of the repeat units of the nonfunctionalized polyolefin (PO2) are derived from an ethylenically unsaturated monomer which is different in chemical nature from that of the repeat units of the nonfunctionalized polyolefin (PO1).

22. The composition according to claim 15, wherein at most 10% by weight of the repeat units of the nonfunctionalized polyolefin (PO2) are derived from an ethylenically unsaturated monomer which is different in chemical nature from that of the repeat units of the nonfunctionalized polyolefin (PO1).

23. The composition according to claim 22, wherein at most 6% by weight of the repeat units of the nonfunctionalized polyolefin (PO2) are derived from an ethylenically unsaturated monomer which is different in chemical nature from that of the repeat units of the nonfunctionalized polyolefin (PO1).

24. The composition according to claim 15, wherein the nonfunctionalized polyolefins (PO1) and (PO2) each exhibit a melting point and in that their respective enthalpies of fusion differ by an amount of between 25 and 75 J/g.

25. The composition according to claim 15, wherein that the weight of the nonfunctionalized polyolefin (PO1) with respect to the total weight of the composition is greater than or equal to 80%.

26. The composition according to claim 15, wherein the weight of the polyolefin (POg) with respect to the total weight of the composition has a value of at most 10%.

27. The composition according to claim 15, wherein it comprises, in addition, up to 5% by weight, with respect to the total weight of the composition, of conventional additives for polyolefin compositions, such as antioxidants, lubricants, fillers, colorants, nucleating agents, UV stabilizers, antacids, metal-deactivating agents and antistatic agents.

28. An article comprising the composition according to claim 15.

29. A polymer composition comprising:
more than 50% by weight, with respect to the total weight of the composition, of a nonfunctionalized polyolefin (PO1), said nonfunctionalized polyolefin (PO1) being a propylene homopolymer; and
more than 0.5% by weight, with respect to the total weight of the composition, of at least one polyolefin comprising carboxyl grafts [polyolefin (POg)] which is functionalized by grafting using at least one grafting agent chosen from ethylenically unsaturated carboxylic acids, their anhydrides and their metal salts, at least a portion of the carboxyl grafts of which is neutralized by a metal, optionally by the neutralization, concomitant with and/or subsequent to the grafting, of the carboxyl grafts by at least one metal base, and which has been synthesized from a nonfunctionalized polyolefin (PO2), said nonfunctionalized polyolefin (PO2) being a random copolymer of propylene and of ethylene comprising at least 94% by weight and at most 98% by weight of repeat units derived from propylene.

30. The composition according to claim 29, wherein the weight of the polyolefin (POg) with respect to the total weight of the composition has a value of at most 10%.

31. The composition according to claim 30, wherein the weight of the nonfunctionalized polyolefin (PO1) with respect to the total weight of the composition is greater than or equal to 80%.

32. An article comprising the composition according to claim 29.

33. A polymer composition comprising
at least 80% by weight, with respect to the total weight of the composition, of a nonfunctionalized polyolefin (PO1); and
more than 0.5% but no more than 10% by weight, with respect to the total weight of the composition, of at least one polyolefin comprising carboxyl grafts [polyolefin (POg)] which is functionalized by grafting using at least one grafting agent chosen from ethylenically unsaturated carboxylic acids, their anhydrides and their metal salts, at least a portion of the carboxyl grafts of which is neutralized by a metal, optionally by the neutralization, concomitant with and/or subsequent to the grafting, of the carboxyl grafts by at least one polyolefin (PO2), at least 0.5% by weight and at most 50% by weight of the repeat units of which are derived from at least one ethylenically unsaturated monomer which has a different chemical nature from that of the repeat units of the nonfunctionalized polyolefin (PO1),
wherein the nonfunctionalized polyolefins (PO1) and (PO2) each exhibit a melting point and their respective enthalpies of fusion differ by an amount of between 25 and 75 J/g.

34. An article comprising the composition according to claim 33.
